(19) United States
(12) Patent Application Publication
(10) Pub. No.: US 2022/0176427 A1
(43) Pub. Date: Jun. 9, 2022

(54) USE OF AT LEAST ONE EPOXIDIZED VEGETABLE OIL OR ONE OF ITS DERIVATIVES IN POLLUTED SOILS

(71) Applicant: Arkema France, Colombes (FR)

(72) Inventors: Markus Brandhorst, PIERRE-BENITE CEDEX (FR); Oliver Chilcott, PIERRE-BENITE CEDEX (FR)

(73) Assignee: Arkema France, Colombes (FR)

(21) Appl. No.: 17/442,910

(22) PCT Filed: Mar. 18, 2020
(86) PCT No.: PCT/FR2020/050584

§ 371 Date: Sep. 24, 2021

(30) Foreign Application Priority Data
Mar. 29, 2019 (FR) FR1903382

(51) Int. Cl. B09C 1/08; B09C 1/10

(52) U.S. Cl. CPC B09C 1/08; B09C 2101/00; B09C 1/10

(57) ABSTRACT

The present invention relates to the use of at least one epoxidized vegetable oil and/or of at least one of its derivatives as a carbon source in polluted soils, in particular for improving the bioremediation of polluted soils.

The invention also relates to a method for bioremediation of polluted soil(s), comprising at least a step of injecting an organic or hydro-organic composition comprising at least one epoxidized vegetable oil and/or at least one of its derivatives into a polluted soil.

### CROSS-REFERENCE TO RELATED APPLICATIONS

This application is the national phase of International Application No. PCT/FR2020/050584, filed 18 Mar. 2020, which claims priority to French Application No. FR 1903382, filed 29 Mar. 2019. the disclosure of each of these applications being incorporated herein by reference in its entirety for all purposes.

### FIELD OF THE INVENTION

The present invention relates to the use of at least one epoxidized vegetable oil and/or at least one of its derivatives as a carbon source in polluted soils, in particular for the bioremediation of polluted soils, more particularly for improving the bioremediation of polluted soils.

The invention also relates to a method for bioremediation of polluted soil(s), comprising at least a step of injecting an organic or hydro-organic composition comprising at least one epoxidized vegetable oil and/or at least one of its derivatives into a polluted soil.

### BACKGROUND OF THE INVENTION

Natural, urban and industrial sites and more generally soils, sediments, surface water, in particular stagnant water or estuaries, or even groundwater may be contaminated by organic or inorganic compounds, such as metals, metal derivatives, or also petroleum hydrocarbons, industrial solvents, in particular chlorinated solvents, agricultural pesticides, pharmaceutical residues and/or by-products resulting from industrial processes.

The desire to clean up these contaminated sites has led in recent years to the development of new technologies based on environmentally friendly biological treatments, the main aim of which is to degrade contaminants and/or convert them into non-toxic substances.

Such processes have the advantage that they can be performed on a large scale while being based on natural phenomena in order to bring the amounts of extractable pollutants below the standards established within a period of time limiting the risks of wider dispersion or contamination.

To this end, the term “bioremediation” typically denotes biological processes using living organisms, most often microscopic living organisms, such as bacteria, microalgae or fungi, or even organisms such as plant species (in the case of phytoremediation), with a view to degrading the polluting substances.

In other words, biological processes based on bioremediation are treatments capable of taking advantage of the natural capacity possessed by organisms, in particular microorganisms, to break down polluting substances. Bioremediation can take place under aerobic conditions and in some cases under anaerobic conditions.

Bioremediation processes make it possible in particular to effectively clean up sites, such as soils or groundwater, most often contaminated by the presence of petroleum hydrocarbons or chlorinated solvents, or the like, by breaking them down due to the presence of bacteria.

Bioremediation processes are generally based on organisms already present in contaminated sites (known as indigenous organisms) or added to said sites (exogenous organisms suitable for the pollutants to be treated). Alternatively, such organisms can be collected from the contaminated site, cultured in the laboratory and then reintroduced into the soil in order to increase the degradation of the contaminants.

Moreover, the natural capacity of microorganisms, in particular bacteria, to biologically degrade polluting substances present in contaminated sites can be increased through the introduction of nutrients, such as for example fertilizers, carbon sources, trace elements and the like, and also optionally by adjusting the conditions of the medium, such as the moisture content and/or the redox potential of the medium.

The fertilizers preferentially include nitrates, such as ammonium nitrates, nitrophosphates, ammonium phosphate sulfate, ammonium sulfate, calcium ammonium nitrates, calcium nitrate, diammonium phosphate, potassium chloride, monoammonium phosphate, sulfate of potash, sulfate of potash and magnesium, single superphosphate, triple superphosphate, urea, sulfur, polyhalite and other complexes or mixture of fertilizers which contain several elements, for example those known under the acronym NPK.

In other words, the activity in situ of microorganisms, in particular bacteria, can be stimulated by the addition of nutrients which will increase their development with a view to improving the bioremediation of polluted sites.

Such nutrients are preferably biodegradable and can be chosen from sugars, for example glucose, lactose or molasses, chitin, or else vegetable oils, for example soybean oil.

In particular, patent application WO 2004/020339 describes the use of an emulsion containing soybean oil in contaminated soils and groundwater in order to promote bioremediation by microorganisms.

Likewise, patent application WO 2014/152350 describes compositions comprising in particular spirulina and lecithin in the form of powders.

However, it proves to be the case that the effectiveness of these nutrients can depend on many parameters, in particular their viscosity, their water-solubility, their biodegradability, their bioavailability, their density and/or their diffusion in the media to be decontaminated, in particular in soils.

Indeed, nutrients with a low viscosity can diffuse too quickly in the media to be decontaminated, in particular in the case of injection into permeable soils, which has the disadvantage that said nutrients are not sufficiently available for increasing the development of microorganisms, in particular bacteria.

As a result, it is important to seek a satisfactory balance between the various parameters mentioned above so as to use nutrients capable of contributing to the development of microorganisms present in contaminated sites.

There is therefore a real need to use nutrients capable of increasing the development of microorganisms present in contaminated sites, in particular in soils, and of stimulating their activity in situ with a view to improving the bioremediation of sites to be decontaminated.

In other words, one of the objectives of the present invention is to provide one or more compounds having satisfactory qualities of biodegradability, bioavailability and diffusion in the media to be decontaminated in order to effectively stimulate the activity in situ of the microorganisms present in contaminated sites.

In particular, one of the objectives of the present invention is to replace the compounds conventionally used as nutrients during bioremediation operations for polluted sites, in order to improve the bioremediation of said sites to be decontaminated, in particular of soils to be decontaminated.

Consequently, it is important to develop new strategies for reducing, or even eliminating, the impact of polluting substances in contaminated sites, in particular soils.

A subject of the present invention is therefore in particular the use of at least one epoxidized vegetable oil and/or of at least one of its derivatives as a carbon source in polluted soils. More particularly, a subject of the invention is the use of at least one epoxidized vegetable oil and/or of at least one of its derivatives in polluted soils, as a carbon source for microorganisms, in particular bacteria.

Thus, the use of at least one epoxidized vegetable oil and/or of at least one of its derivatives as a carbon source makes it possible to effectively increase the development of microorganisms, in particular bacteria, and to stimulate their activity in situ for the bioremediation of sites to be decontaminated, and in particular with a view to improving the bioremediation of sites to be decontaminated.

In particular, the epoxidized vegetable oils or epoxidized vegetable oil derivatives exhibit an advantageous diffusion in the soils to be decontaminated, in particular in soils having a more or less high permeability, and also suitable biodegradability and bioavailability parameters in order to effectively stimulate the natural capacity of microorganisms to biologically degrade polluting substances found in such soils.

Epoxidized vegetable oils and also epoxidized vegetable oil derivatives have in particular the advantage of being more effective as nutrients, providing a carbon source for microorganisms in soils having a greater or lesser permeability, than their non-epoxidized homologs, in particular compared to an identical vegetable oil free of epoxide group.

This is because epoxidized vegetable oils and also epoxidized vegetable oil derivatives diffuse more slowly in soils having a greater or lesser permeability which makes them more biologically available as a carbon source for microorganisms, in particular bacteria, than an identical vegetable oil free of epoxide group.

In other words, the epoxidized vegetable oils and/or their derivatives used according to the invention make it possible to further stimulate the activity in situ of microorganisms, in particular bacteria, by increasing their development, and to further increase the bioremediation of soils to be decontaminated compared to a vegetable oil free of epoxide group.

In addition, the epoxidized vegetable oils or their derivatives according to the invention can be easily formulated in a water-in-oil or oil-in-water emulsion, and prove to be more stable than a conventional vegetable oil free of epoxide group formulated under the same conditions.

The result is that the epoxidized vegetable oils or their derivatives according to the invention exhibit conditions of use that are simpler than the conventionally used vegetable oils which are free of epoxide group.

At the same time, the epoxidized vegetable oils and/or their derivatives can prove to be less water-soluble than certain nutrients such as molasses, which also makes them more efficient in permeable soils.

In other words, the epoxidized vegetable oils and/or their derivatives used according to the invention are more advantageous as a carbon source for microorganisms, in particular for bacteria, than the nutrients conventionally used until now.

More generally, by virtue of their viscosity, their solubility, their biodegradability and also their bioavailability, the epoxidized vegetable oils and/or their derivatives according to the invention are nutrients which can be used in a versatile manner depending on their formulations and applications, that is to say that their parameters allow them to adapt effectively to various types of soil.

Another subject of the present invention relates to a method for bioremediation of polluted soils, comprising at least a step of injecting an organic or hydro-organic composition comprising at least one epoxidized vegetable oil and/or at least one epoxidized vegetable oil derivative into a soil.

The injection of an organic or hydro-organic composition comprising at least one epoxidized vegetable oil and/or at least one of its derivatives as defined above into a polluted soil makes it possible to increase the in situ activity of the microorganisms and to increase their capacity to biologically degrade the polluting substances present in such a soil.

Thus, the method according to the invention makes it possible to stimulate the biodegradation in situ of polluted soils.

In particular, the method according to the invention makes it possible to increase the development of microorganisms, in particular bacteria, in polluted soils and, consequently, to accelerate bioremediation.

The method according to the present invention has the advantage of being able to treat various types of soils, that is to say of cleaning soils contaminated by various polluting substances and/or having various degrees of permeability.

Other characteristics and advantages of the invention will become more clearly apparent on reading the description and the examples which follow.

In what will follow, and unless otherwise indicated, the limits of a range of values are included in this range.

The expression “at least one” is equivalent to the expression “one or more”.

### SUMMARY OF THE INVENTION

As indicated above, the present invention relates to the use of at least one epoxidized vegetable oil and/or of at least one of its derivatives as a carbon source in polluted soils.

Preferably, the epoxidized vegetable oil and/or one of its derivatives is (or are) used as a carbon source for microorganisms, in particular for bacteria, present in polluted soils.

More preferentially, the epoxidized vegetable oil and/or one of its derivatives is (or are) used as a carbon source for stimulating and thus improving the activity in situ of the bacteria.

In other words, the epoxidized vegetable oil and/or one of its derivatives is (or are) used as a carbon source for increasing the development of bacteria and stimulating their natural capacity to biologically degrade the polluting substances found in contaminated soils.

The bacterium or bacteria present in polluted soils can be of any known genus; bacteria of the genus Pseudomonas, Achromobacter, Arthrobacter, Bacillus, Lactobacillus, Micrococcus, Nocardia, Vibrio, Acinetobacter, Brevibacterium, Corynebacterium, Flavobacterium, Leucothrix, Rhizobium, Spirillum, Xanthomonas, Alcaligenes, Cytophaga, Thermomicrobium, Klebsiella, Enterobacter, Blastochlorer, Thaurea, Azoarcus, Dechloromonas, Geobacter, Sphingomonas, Desborobacter, Desulfobacula, Desulfobacterium, Sulfurospirillum, Dehalobacter, Dehalococcoides or Spha, or any combination of two or more thereof, can in particular be identified.

The bacterium or bacteria present in the polluted soils is (or are) preferably anaerobic bacteria.

Preferably, the epoxidized vegetable oil and/or one of its derivatives is (or are) used for improving the bioremediation of polluted soils.

Even more preferentially, the epoxidized vegetable oil and/or one of its derivatives is (or are) used for accelerating the bioremediation of polluted soils.

### DETAILED DESCRIPTION OF THE INVENTION

The polluted soil(s) that can be treated by the present invention comprise(s) one or more organic polluting substances.

Preferably, the polluted soil(s) that can be treated by the present invention comprise(s) one or more organic polluting substance(s) chosen from the group consisting of hydrocarbons, in particular linear C₆-C₃₀ hydrocarbons, cyclic hydrocarbons, polycyclic hydrocarbons, solvents, in particular halogenated solvents, or mixtures thereof, and in particular chlorinated solvents, or mixtures thereof.

More preferentially, the polluted soil(s) that can be treated by the present invention comprise(s) one or more organic polluting substance(s) chosen from the group consisting of hexane, octane, benzene, toluene, ethylbenzene, xylene, polycyclic aromatic hydrocarbons (PAHs) such as anthracene, naphthalene, pyrene, tetracene, coronene, benzopyrene, chrysene, phenanthrene, polychlorinated biphenyls (PCBs), chlorinated solvents, such as for example tetrachloroethylene and trichloroethylene, and mixtures thereof.

Even more preferentially, the polluted soil(s) that can be treated by the present invention comprise(s) one or more organic polluting substance(s) chosen from the group consisting of hydrocarbons, preferably hexane, octane, polycyclic aromatic hydrocarbons (PAHs), polychlorinated biphenyls (PCBs), halogenated solvents, in particular chlorinated solvents, and mixtures thereof.

Even more preferably, the polluted soil(s) that can be treated by the present invention comprise(s) one or more organic polluting substance(s) chosen from halogenated solvents, in particular chlorinated solvents, and mixtures thereof.

The epoxidized vegetable oils and/or their epoxidized vegetable oil derivatives that can be used in the context of the present invention are effective for all ranges of soil permeability, and more particularly for permeable to very permeable soils.

Preferably, the epoxidized vegetable oil and/or its derivatives has (have) a viscosity ranging from 4 mPa·s to 700 mPa·s, in particular ranging from 25 mPa·s to 650 mPa·s, measured at a temperature of 25° C., as measured for example using an Ostwald viscometer.

The epoxidized vegetable oil(s) used according to the invention is or are in particular liquid triglycerides of unsaturated C₆-C₃₀, preferably C₁₀-C₂₄, in particular C₁₂-C₂₂, fatty acids which have undergone an epoxidation reaction, that is to say which comprise at least one epoxide function.

Thus, the epoxidized vegetable oils according to the invention are preferably prepared from:
vegetable oil extracted from an oleaginous plant,
an esterification reaction between one or more unsaturated C₆-C₃₀, preferably C₁₀-C₂₄, in particular C₁₄-C₂₂, carboxylic fatty acids and glycerol in order to obtain triglycerides of unsaturated fatty acids,
an epoxidation reaction of the triglycerides of unsaturated fatty acids previously obtained in the presence of an organic peracid, formed with aqueous hydrogen peroxide, and for example performic acid or peracetic acid, and where appropriate an acid catalyst such as sulfuric or phosphoric acid.

The term “unsaturated fatty acids” means that the fatty chain comprises at least one unsaturation, preferably in the form of a double bond, which can be involved in an epoxidation reaction as indicated above.

The epoxidized vegetable oil(s) used according to the invention comprise(s) in its structure or their structure at least one epoxide group.

In other words, the vegetable oils according to the invention are in particular liquid triglycerides of unsaturated C₆-C₃₀, preferably C₁₄-C₂₂, in particular C₁₂-C₂₂, fatty acids which comprise in their structure at least one epoxide group.

For the purposes of the present invention, the term “liquid” is understood to mean that the vegetable oil is liquid at a temperature of 25° C. and at atmospheric pressure (760 mmHg, i.e. 1013.25 hPa).

Preferably, the epoxidized vegetable oil(s) according to the invention comprise(s) a number of epoxide groups ranging from 1 to 9, preferably ranging from 1 to 6, more preferably ranging from 2 to 6.

Preferentially, the epoxidized vegetable oil used according to the invention is chosen from the group consisting of epoxidized soybean oil, epoxidized palm oil, epoxidized rapeseed oil, epoxidized linseed oil, epoxidized sunflower oil, epoxidized peanut oil, epoxidized camphor oil, epoxidized castor oil, and mixtures thereof.

More preferentially, the epoxidized vegetable oil used according to the invention is epoxidized soybean oil, in particular the epoxidized soybean oil sold under the trade name Vikoflex® 7177 (obtained in the presence of formic acid) and Vikoflex® 7170 (obtained in the presence of acetic acid) by the company Arkema.

For the purposes of the present invention, the term “an epoxidized vegetable oil derivative” is understood to mean a compound which has been synthesized from a vegetable oil as described above. In other words, an epoxidized vegetable oil derivative corresponds to a vegetable oil which has been chemically modified, or else a compound obtained after opening one or more epoxy rings (i.e. epoxide group) of said epoxidized vegetable oil.

Preferably, the present invention relates to the use of at least one epoxidized vegetable oil and/or at least one epoxidized vegetable oil ester (transesterification of vegetable oil).

Preferably, the epoxidized vegetable oil ester used in the context of the present invention is more particularly chosen from the group consisting of methyl esters of an epoxidized vegetable oil.

More preferentially, the epoxidized vegetable oil ester used according to the invention is a methyl ester of epoxidized soybean oil, in particular that sold under the trade name Vikoflex® 7010 by the company Arkema.

Preferably, the present invention relates to the use of at least one epoxidized vegetable oil and/or of at least one ester of an epoxidized vegetable oil as a carbon source in polluted soils.

More preferentially, the invention relates to the use of an epoxidized soybean oil and/or of an epoxidized soybean oil ester as a carbon source in polluted soils.

More preferentially, the epoxidized soybean oil and/or the epoxidized soybean oil ester is used for improving the bioremediation of polluted soils, in particular for accelerating the bioremediation of soils.

Advantageously, the invention relates to the use of an epoxidized soybean oil as a carbon source in polluted soils.

Alternatively, the invention also relates to the use of an ester of an epoxidized soybean oil as a carbon source in polluted soils.

In particular, the methyl ester of an epoxidized soybean oil is used as a carbon source in polluted soils.

Again alternatively, the invention also relates to the use of an epoxidized soybean oil and of an ester of an epoxidized soybean oil as a carbon source in polluted soils.

Advantageously, the epoxidized vegetable oil and/or one of its derivatives can be used as a carbon source in polluted soils in combination with one or more other nutrients.

Preferably, these nutrients are chosen from the group consisting of sugars or vegetable oils free of epoxide groups.

The invention also relates to a method for bioremediation of polluted soils, comprising at least a step of injecting an organic or hydro-organic composition comprising at least one epoxidized vegetable oil and/or one of its derivatives as defined above into at least one area of a polluted soil, as defined above, or near such an area.

As indicated above, the soil contains one or more organic substances as defined above.

Preferably, the epoxidized vegetable oil and/or one of its derivatives is in a content ranging from 1% to 100% by weight, preferably ranging from 5% to 100% by weight, preferably ranging from 10% to 100% by weight, preferably ranging from 20% to 100% by weight relative to the total weight of the composition.

The composition can also comprise one or more nutrients such as sugars or vegetable oils free of epoxide groups.

The method according to the invention makes it possible in particular to activate, stimulate or even improve the bioremediation of organic substances by means of the microorganisms, in particular bacteria, mentioned above.

Preferably, the composition comprises at least one epoxidized vegetable oil and/or at least one ester of an epoxidized vegetable oil.

The following examples serve to illustrate the invention without, however, exhibiting a limiting nature.

### EXAMPLE

In the following example, the diffusion in sand between an epoxidized soybean oil, a methyl ester of an epoxidized soybean oil and a pure soybean oil, i.e. a vegetable oil not modified by epoxidation, was compared.

### I. Protocol

### 1. Preparation of Emulsions

Emulsions comprising 30 g of tap water, 70 g of organic compound (soybean oil, commercial products Vikoflex® 7177 and Vikoflex® 7170) and 0.1 g of a dye (Solvent Violet 59, C162025, CAS 6408-72-6) were prepared by rapid stirring for a period of 15 minutes in a closed container using a magnetic stirrer bar.

The dye used is organic in nature and is only soluble in the organic phase of the emulsions prepared.

The dye is used to visualize the progress of the organic phase. A verification by total carbon analysis confirmed that very little (content less than 0.6 mg.I⁻¹) carbon is found in the colorless phase, and the colored phase corresponds to the organic phase.

2. Preparation of the Chromatography Column

A chromatography column (diameter 3 cm), with sintered glass disk and stopcock was filled (stopcock closed) with 10 cm of soil from Saint-Auban (Durance valley, France) sieved to a grain size of less than 1600 μm.

The column was filled with water to the upper level of the soil.

The stirring of the emulsion was then stopped and the emulsion was added to the chromatography column until a level of 5 cm above the soil was reached.

The chromatography column was then pressurized with a constant air flow, regulated by a Brooks R2 15C flowmeter.

A timer was started at the moment the stopcock was opened so as to measure the time for the emulsion to percolate through the soil.

A colorless phase was first collected and then the timer was stopped when a colored drop dripped from the sintered glass.

### II. Results

The results are collated in table 1 below:

TABLE 1

| | Sand | Emulsion | Emulsion percolation |
|---|---|---|---|
| Oils tested | weight (g) | weight (g) | time |
| 1: Vikoflex ® 7177 | 68.9 | 24.3 | 31 min |
| 1: Vikoflex ® 7177 | 66.4 | 23.4 | 29 min |
| 1: Vikoflex ® 7177 | 66.9 | 22.9 | 34 min |
| 1: Vikoflex ® 7177 | 65 | 19.9 | 29 min |
| 1: Vikoflex ® 7177 | 66.9 | 20 | 32 min |
| 2: Vikoflex ® 7170 | 67.5 | 21.8 | 47 min |
| 2: Vikoflex ® 7170 | 67.9 | 21.7 | 47 min |
| 2: Vikoflex ® 7170 | 67 | 23 | 46 min |
| 2: Vikoflex ® 7170 | 68.7 | 24 | 51 min |
| 3: Non-epoxidized | 66.1 | 21.4 | 4 min 30 sec |
| soybean oil | | | |
| 3: Non-epoxidized | 66 | 22.5 | 4 min 30 sec |
| soybean oil | | | |
| 3: Non-epoxidized | 66.3 | 22 | 4 min 20 sec |
| soybean oil | | | |
| 3: Non-epoxidized | 66.15 | 22.4 | 5 min 20 sec |
| soybean oil | | | |

The results show that the epoxidized soybean oil sold under the name Vikoflex® 7177 and the epoxidized soybean oil sold under the name Vikoflex® 7170 diffuse more slowly than pure soybean oil in permeable soils.

Consequently, the epoxidized soybean oil sold under the name Vikoflex® 7177 and the epoxidized soybean oil sold under the name Vikoflex® 7170 are more biologically available as a carbon source for bacteria than an identical vegetable oil free of epoxide group.

1. The use of at least one epoxidized vegetable oil and/or of at least one of its derivatives in polluted soils, as a carbon source for microorganisms.

2. The use as claimed in claim 1, for the bioremediation of said polluted soils.

3. The use as claimed in claim 1 as a carbon source for accelerating bioremediation in polluted soils.

4. The use as claimed in claim 1, wherein the epoxidized vegetable oil and/or one of its derivatives is or are a carbon source for microorganisms.

5. The use as claimed in claim , wherein the polluted soils comprise(s) one or more organic polluting substances.

6. The use as claimed in claim 5, wherein the organic polluting substance(s) is or are chosen from the group consisting of hexane, octane, benzene, toluene, ethylbenzene, xylene, polycyclic aromatic hydrocarbons (PAHs) polychlorinated biphenyls (PCBs), chlorinated solvents, and mixtures thereof.

7. The use as claimed in claim 5, wherein the soils are permeable to very permeable.

8. The use as claimed in claim 5, wherein the epoxidized vegetable oil is chosen from the group consisting of liquid triglycerides of unsaturated C6-C30fatty acids which have undergone an epoxidation reaction.

9. The use as claimed in claim 5, wherein the epoxidized vegetable oil comprises a number of epoxide groups ranging from 1 to 9.

10. The use as claimed in claim 5, wherein the epoxidized vegetable oil is chosen from the group consisting of epoxidized soybean oil, epoxidized palm oil, epoxidized rapeseed oil, epoxidized linseed oil, epoxidized sunflower oil, epoxidized peanut oil, epoxidized camphor oil, epoxidized castor oil, and mixtures thereof.

11. The use as claimed in claim 5, wherein the epoxidized vegetable oil derivative(s) is or are chosen from the group consisting of esters of an epoxidized vegetable oil.

12. The use as claimed in claim 11, wherein the epoxidized vegetable oil derivative is an epoxidized soybean oil ester.

13. A method for bioremediation of polluted soils, comprising at least a step of injecting an organic or hydro-organic composition comprising at least one epoxidized vegetable oil and/or one of its derivatives as defined in claim 1 into at least one area of a polluted soil or near such an area.

14. The method for bioremediation as claimed in claim 13, wherein the epoxidized vegetable oil and/or one of its derivatives is in a content ranging from 1% to 100% by weight relative to the total weight of the composition.

15. The method as claimed in claim 13, wherein the composition also comprises one or more other nutrients.
